(19) United States
(12) Patent Application Publication
(10) Pub. No.: US 2019/0131066 A1
(43) Pub. Date: May 2, 2019

(54) GRAIN BOUNDARY DIFFUSION TECHNOLOGY FOR RARE EARTH MAGNETS

(71) Applicant: Ford Global Technologies, LLC, Dearborn, MI (US)

(72) Inventors: C. Bing Rong, Canton, MI (US); Feng Liang, Troy, MI (US); Michael Degner, Novi, MI (US); Wanfeng Li, Novi, MI (US)

(73) Assignee: Ford Global Technologies, LLC, Dearborn, MI (US)

(21) Appl. No.: 15/795,208

(22) Filed: Oct. 26, 2017

(51) Int. Cl. H01F 41/02; H01F 1/057; B22F 1/02

(52) U.S. Cl. CPC H01F 41/0293; B22F 1/025; H01F 41/0266; H01F 1/0576

(57) ABSTRACT

A grain boundary diffusion method for a rare-earth (RE) magnet is provided. The method includes coating particles of the RE magnet with a coating material. Each RE magnet particle includes a plurality of grains. The coated particles are then simultaneously heat treated and compacted. The heat treated, compacted, and coated particles are then formed into a rare earth magnet. In a form of the method, the heat treated, compacted, and coated particles are hot deformed prior to being formed into a rare earth magnet. Another form of the method achieves the grain boundary diffusion without first sintering the rare earth magnet.

### FIELD

The present disclosure relates to grain boundary diffusion technology, and more particularly to grain boundary diffusion methods for the manufacture of rare earth magnets.

### BACKGROUND

The statements in this section merely provide background information related to the present disclosure and may not constitute prior art.

Conventional rare-earth (RE) sintered magnets use a large amount of heavy rare earth (HRE) material in the sintered magnets to meet the desired elevated temperature environmental requirements. To reduce the HRE content in the sintered magnets, a grain boundary diffusion process follows the sintering process. The general procedure includes producing a sintered magnet with micro-scale grains from micron magnetic powders. Coating the sintered magnet with a layer of HRE-containing materials. The HRE-containing materials comprise -fluoride, -hydride, and -oxide, HRE materials. Heating the HRE coated sintered magnet to diffuse the HRE from the coating layer to the grain boundaries of the sintered magnet. This HRE diffusion along the grain boundaries is usually limits magnet thickness to about 6 mm. The HRE diffused magnets often have non-homogenous properties such as the coercivity at the center of the magnet being less than the coercivity in the diffused grain boundaries. Further, the HRE of the base sintered magnet may be significantly reduced during the grain boundary diffusion.

Another way to reduce the HRE content in the sintered magnets is to form anisotropic magnets, where the c-axis of the grains are all aligned in one direction. These anisotropic magnets are generally made by the hot deformation of magnetic flakes or ribbons. Magnetic flakes or ribbons, as the names imply have large aspect ratios (length over diameter (l/d) or length over thickness (l/t) and their diameter or thickness is measured in microns. Often the magnetic flakes or ribbons have grains ranging in size from the nano-scale to the micro-scale. The general hot deformation procedure includes placing magnetic flakes or ribbons into a hot press, heating the hot press, and pressing the magnetic flakes or ribbons to compact them into an anisotropic magnet. In the hot deformation process, anisotropic magnets may be produced with all grains are aligned one direction. The grain boundary diffusion process of HRE sintered magnets is not as efficient in conjunction with hot deformation of anisotropic magnets because the grain boundaries of the anisotropic magnets are very thin.

The present disclosure addresses these and other issues related to forming rare earth magnetic articles.

### SUMMARY

In a form of the present disclosure, a method of grain boundary diffusion for a rare-earth (RE) magnet is provided. The method comprises coating particles of the RE magnet with a coating material, wherein each particle includes a plurality of grains, and simultaneously heat treating and compacting the coated particles.

In one form, the step of simultaneously heat treating and compacting includes hot deformation of the coated particles. The particles may be powders, ribbons, and flakes, or the particles may be nano-particles, sub-micron particles, or small micron particles. The coating material for the particles may be a fluoride, hydride, or oxide containing a heavy rare earth (HRE) element.

The coating material for the particles is at least one of a heavy rare earth (HRE) alloy, an HRE compound, a light rare earth (LRE) alloy, an LRE compound, a non-magnetic material, a non-RE material, and combinations thereof. The HRE alloys may include, by way of example, Dy, Tb, Dy—Fe, and Tb—Fe, and the LRE alloys may include, by way of example, Nd—Fe, Nd—Cu, and Pr—Cu.

In the coating step, a variety of methods may be employed, including but not limited to chemical synthesis, gas-powder spraying, sol-gel, and combinations thereof. The coating step may further include mixing a powder with the particles. Further, the coating material may be dispersed in a liquid for coating.

In another form of the present disclosure, a method of grain boundary diffusion for a rare-earth (RE) magnet is provided. The method comprises coating particles of the RE magnet with a coating material, wherein each particle includes a plurality of grains. The method further includes simultaneously heat treating and compacting the coated particles, wherein the step of heat treating and compacting includes hot deformation of the coated particles. In this form, the particles may be powders, ribbons, and flakes, or the particles may be nano-particles, sub-micron particles, and small micron particles. The coating step includes, by way of example, chemical synthesis, gas-powder spraying, and sol-gel. The coating may also include mixing a powder with the particles. The coating material for the particles may be a heavy rare earth (HRE) alloy, an HRE compound, a light rare earth (LRE) alloy, an LRE compound, a non-magnetic material, a non-RE material, and combinations thereof.

In still another form of the present disclosure, a method of grain boundary diffusion for a rare-earth (RE) magnet is provided. The method comprises coating particles of the RE magnet with a coating material, wherein each particle includes a plurality of grains. The method includes simultaneously heat treating and compacting the coated particles, wherein the grain boundary diffusion is achieved without first sintering the RE magnet. In this method, the step of heat treating and compacting includes hot deformation of the coated particles.

The present disclosure also includes a magnet formed by the various methods of the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIGS. 1A, 1B, and 1C are a series of exemplary illustrations of grain boundaries and diffusion of the grain boundaries according to the teachings of the present disclosure;

FIG. 2 is a schematic view of an exemplary gas-powder-spraying method for coating particles according to the teachings of the present disclosure;

FIGS. 3A and 3B are schematic views of an exemplary grain boundary diffusion heat treatment with simultaneous hot compaction arrangement according to the teachings of the present disclosure;

FIGS. 4A and 4B are schematic views an exemplary grain boundary diffusion heat treatment with a simultaneous hot deformation arrangement according to the teachings of the present disclosure; and

FIG. 5 is a flow chart of an exemplary method for rare earth magnet grain boundary diffusion according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides a new grain boundary diffusion method to improve grain boundary diffusion efficiency. The present disclosure reduces the amount of heavy rare earth (HRE) material while providing comparable magnetic properties without the traditional heat treatment process of grain boundary diffusion for conventional sintered magnets. The present disclosure provides grain boundary diffusion for magnets with, by way of example, nano-scale (10̂-10 m) to micro-scale (10-3 m) grains.

The present disclosure significantly improves HRE-diffusion efficiency through a novel procedure. Typical precursor micro-particles comprising nano-scale to micro-scale grains are flakes, powders, and ribbons.

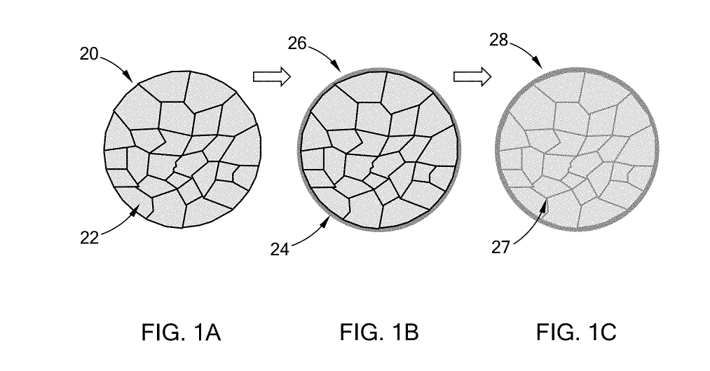

Referring to FIG. 1A, these micro-particles 20 (e.g., raw flakes, powders, and ribbons) have at least one dimension that is in the micron (10̂-7 m) scale or larger, but each micro-particle comprises multiple grains 22. As shown in FIG. 1B, the coating material 24 (HRE or other material) is applied to the micro-particles 20 forming coated micro-particles 26. This differs from conventional methods as each particle is coated instead of being a sintered magnet. Further, the grain boundary diffusion of the present disclosure is unexpectedly applicable to non-sintered rare earth magnets. Referring to FIG. 1C, a heat treatment, appropriate to the coating material as described in greater detail below, diffuses the coating material 24 into the grain boundaries between the nano-scale or micro-scale grains of the particles 20, creating coated grains 27 and diffused micro-particles 28.

Coating materials according to the present disclosure comprise HRE-containing materials (i.e. alloys, compounds, elements, metals, and oxides), light rare earth (LRE)-containing materials, rare earth materials, non-rare earth (RE) materials, non-magnetic materials, and other materials. HRE-containing compounds include fluoride, hydride, oxide, or other compounds containing HRE elements. HRE-containing alloys include Dy, DyFe, Tb, TbFe, and other HRE element alloys. LRE-containing alloys include Nd—Fe, Nd—Cu, Pr—Cu, and other LRE element alloys. Coating materials could be in powder form, mixed with the magnetic powders, ribbons, and flakes, or dispersed in a liquid.

Coating methods according to the present disclosure comprise chemical synthesis coating, the sol-gel method, gas-powder-spraying methods, and combinations thereof.

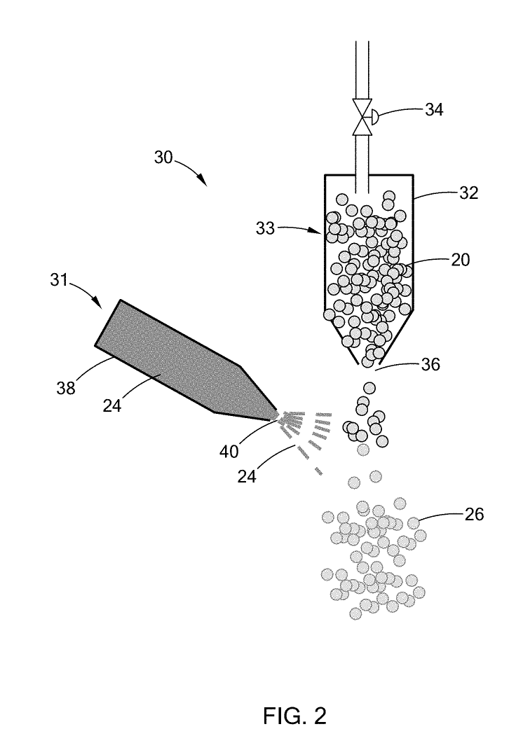

Referring to FIG. 2, in a gas-powder-spraying method, a gas-powder-spraying apparatus 30 comprises a gas-powder-spray controller (not shown), a coating material apparatus 31, and a powder dispersion apparatus 33. The powder dispersion apparatus 33 includes particles (powder) or micro-particles 20 contained in a particle vessel 32, that has a particle gas control 34, a particle inlet (not shown), and a particle ejection port (nozzle) 36. The coating material apparatus 31 includes coating materials contained in a coating material vessel 38, which has a coating material gas control (not shown), a coating material inlet (not shown), and a coating material ejection port 40. The gas-powder-spray controller (not shown) is operable to open and close at least one of the gas controllers (coating material and particle), the ejection ports (coating material and particle), and the inlets (coating material and particle). Particles enter the particle vessel through the particle inlet, the particle gas control releases gas into the powder vessel, the pressure causes the particles to be ejected from the particle vessel through the particle ejection port. The coating material moves similarly through the coating material apparatus. The particles are coated with the coating material after they are ejected from their respective ports.

The grain boundary diffusion heat treatments according to the present disclosure comprise conventional heat treatment, simultaneously with hot compaction, and simultaneous with hot deformation.

Conventional grain boundary diffusion heat treatments include heating to at least one specific temperature and holding at that temperature for a time. Conventional heat treatments also include quenches and cooling procedures. As an example, the heat treatment could include heating to 500-800° C. (932-1472° F.) for 30-60 minutes, followed by an air or furnace cooling.

During simultaneous heat treating and compaction, the coated particles are placed within a mold capable of being heated and pressed. The mold is placed within a furnace or hot press and heated to 400-900° C. (752-1,652° F.). When a furnace is used, the hot mold is transferred to a press. The heated and coated materials are then pressed for a few minutes to a few hours, depending on desired magnetic properties.

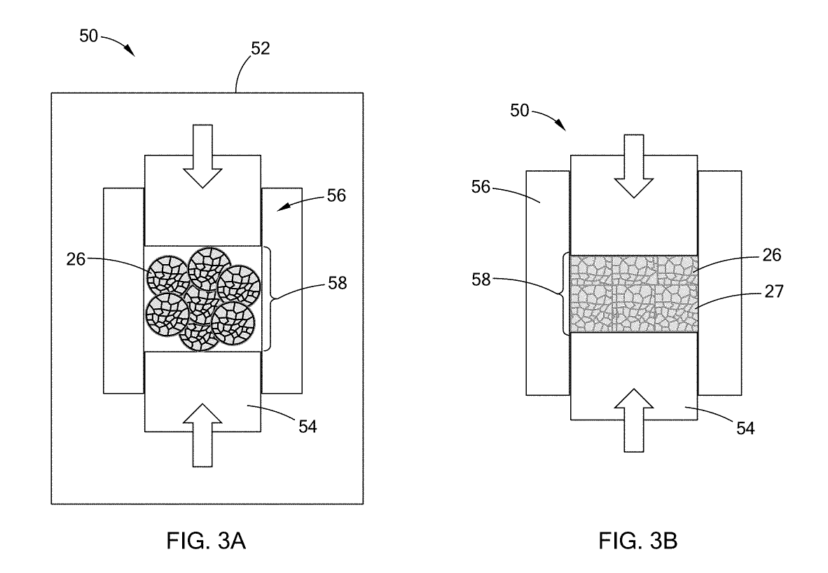

Referring to FIG. 3A, in one form, the coated micro-particles 26 are placed within a hot press 50. The hot press comprises a heating chamber 52 with a punch 54 and a die 56, which forms a desired shape 58. The hot press is brought to temperature, the punch and die are engaged applying pressure (arrows) and heat to the coated micro-particles 26, and the hot micro-particles are pressed and compacted (FIG. 3B) into shape 58. During the heating and pressing, the coating 24 (FIG. 3A) diffuses along the surface of the particles and into the grain boundaries (FIG. 3B) of the micro-particles creating coated grains 27. Thus, the resulting RE magnet has desired magnetic properties throughout. Hot-pressing also forms the micro-particles into the desired shape 58 for the rare earth magnet.

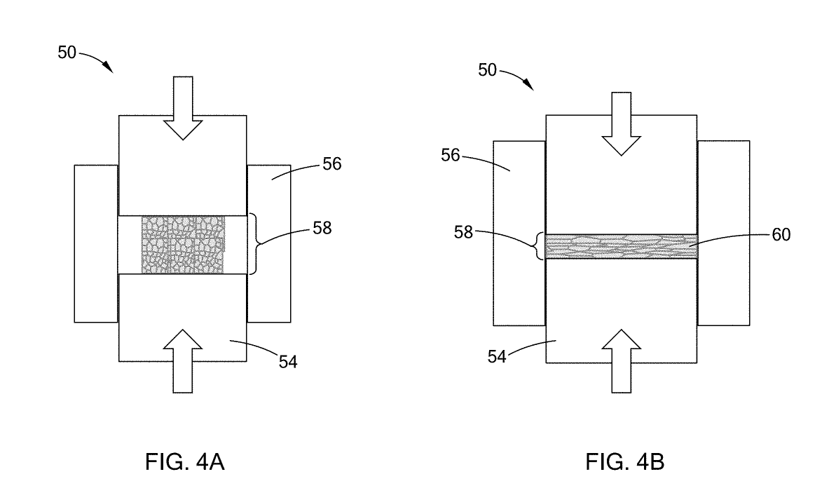

Referring now to FIGS. 4A and 4B, grain boundary diffusion heat treatment with simultaneous hot deformation is shown. In FIG. 4A, pressure is applied to the particles (arrows), and with continued pressure in the hot deformation step (FIG. 4B), the coating is diffused into the grains and the grains are deformed 60. In one example, this method is carried out in the 500-900° C. (932-1652° F.) temperature range, which depends on the materials being processed. Further, the hot deformation step (FIG. 4B) may initiate recovery, recrystallization, and grain growth in the coating or the micro-particles. The hot deformation step includes various methods of hot working including drawing, extruding, forging, pressing, rolling of the rare earth magnet, and combinations thereof.

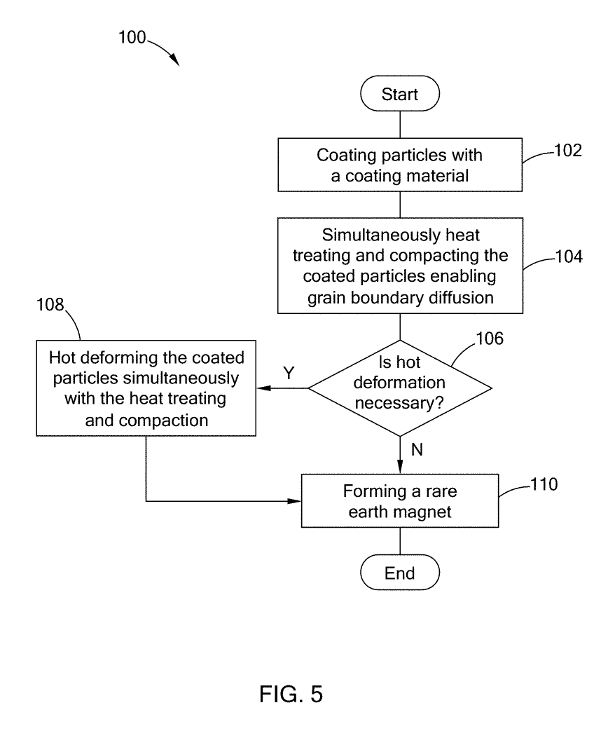

Referring to FIG. 5, a method of a grain boundary diffusion for a rare-earth (RE) magnet (FIG. 5) is shown in a flow diagram. The method 100 comprises coating particles of the RE magnet with a coating material (102), wherein each particle includes a plurality of grains. This coating is followed by simultaneously heat treating and compacting the coated particles (104). The decision whether to hot deform the coated particles (106) is made based upon the requirements of the rare earth magnet. If the coated particles are to be subjected to hot deformation, the hot deformation is performed at least one of after, before, and simultaneous to the heat treating and compacting of the coated particles 108. As a result, a rare earth magnet is formed 110.

The particles may include powders, ribbons, and flakes, while the particles may be nano-particles (10̂-10 to 10̂-7 m), sub-micron (10̂-7 to 10̂-6 m) particles, small micron (10̂-6 to 10̂-4 m particles, and combinations thereof.

In a method of the present disclosure, the coating material for the particles is a fluoride, hydride, or oxide containing a heavy rare earth (HRE) element. The coating may also be at least one of a heavy rare earth (HRE) alloy, an HRE compound, a light rare earth (LRE) alloy, an LRE compound, a non-magnetic material, a non-RE material, and combinations thereof. The HRE alloy is selected from the group consisting of Dy, Tb, Dy—Fe, and Tb—Fe, and the LRE alloy is selected from the group consisting of Nd—Fe, Nd—Cu, and Pr—Cu.

The coating step may include chemical synthesis, gas-powder spraying, sol-gel, and combinations thereof. The coating step may also include mixing a powder with the particles.

In one form, the coating material is dispersed in a liquid for coating.

A form of the present disclosure includes a rare earth magnet formed by the various methods of the present disclosure.

In yet another method of the present disclosure, the grain boundary diffusion is achieved without first sintering the rare earth magnet.

In a form of the present disclosure, the micro-particles are non-homogenously arranged within the hot-press to meet general or desired RE-magnet specifications. The hot-pressing is performed to improve and augment the desired specifications of the RE-magnet. For example, different micro-particles could be combined with different properties to reduce the use of expensive HRE coated micro-particles. The sub-assembly can then be hot-pressed, thus providing improved HRE-properties where needed in the RE-magnet.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of grain boundary diffusion for a rare-earth (RE) magnet comprising:
coating particles of the RE magnet with a coating material, wherein each particle includes a plurality of grains; and
simultaneously heat treating and compacting the coated particles.

2. The method according to claim 1, wherein the step of heat treating and compacting includes hot deformation of the coated particles.

3. The method according to claim 1, wherein the particles are selected from the group consisting of powders, ribbons, and flakes.

4. The method according to claim 3, wherein the particles are selected from the group consisting of nano-particles, sub-micron particles, and small micron particles.

5. The method according to claim 1, wherein the coating material for the particles is at least one of a fluoride, hydride, and oxide containing a heavy rare earth (HRE) element.

6. The method according to claim 1, wherein the coating material for the particles is at least one of a heavy rare earth (HRE) alloy, an HRE compound, a light rare earth (LRE) alloy, an LRE compound, a non-magnetic material, a non-RE material, and combinations thereof.

7. The method according to claim 6, wherein the HRE alloy is selected from the group consisting of Dy, Tb, Dy—Fe, and Tb—Fe, and the LRE alloy is selected from the group consisting of Nd—Fe, Nd—Cu, and Pr—Cu.

8. The method according to claim 1, wherein the coating step comprises a method selected from the group consisting of chemical synthesis, gas-powder spraying, sol-gel, and combinations thereof.

9. The method according to claim 1, wherein the coating step comprises mixing a powder with the particles.

10. The method according to claim 1, wherein the coating material is dispersed in a liquid for coating.

11. A magnet formed according to the method of claim 1.

12. A method of grain boundary diffusion for a rare-earth (RE) magnet comprising:
coating particles of the RE magnet with a coating material, wherein each particle includes a plurality of grains; and
simultaneously heat treating and compacting the coated particles, wherein the step of heat treating and compacting includes hot deformation of the coated particles.

13. The method according to claim 12, wherein the particles are selected from the group consisting of powders, ribbons, and flakes.

14. The method according to claim 13, wherein the particles are selected from the group consisting of nano-particles, sub-micron particles, and small micron particles.

15. The method according to claim 12, wherein the coating step comprises a method selected from the group consisting of chemical synthesis, gas-powder spraying, sol-gel, and combinations thereof.

16. The method according to claim 12, wherein the coating material for the particles is a heavy rare earth (HRE) alloy, an HRE compound, a light rare earth (LRE) alloy, an LRE compound, a non-magnetic material, a non-RE material, and combinations thereof.

17. The method according to claim 12, wherein the coating step comprises mixing a powder with the particles.

18. A magnet formed according to the method of claim 12.

19. A method of grain boundary diffusion for a rare-earth (RE) magnet comprising:
coating particles of the RE magnet with a coating material, wherein each particle includes a plurality of grains; and
simultaneously heat treating and compacting the coated particles,
wherein the grain boundary diffusion is achieved without first sintering the RE magnet.

20. The method according to claim 19, wherein the step of heat treating and compacting includes hot deformation of the coated particles.
